(19) United States
(12) Patent Application Publication
(10) Pub. No.: US 2026/0189369 A1
(43) Pub. Date: Jul. 2, 2026

(54) SYSTEM AND METHOD FOR ENCRYPTED COMMUNICATION

(71) Applicant: Uranus Universal (Beijing) Technology Co., Ltd., Beijing (CN)

(72) Inventor: Haifeng WU, Beijing (CN)

(73) Assignee: Uranus Universal (Beijing) Technology Co., Ltd., Beijing (CN)

(21) Appl. No.: 19/411,408

(22) Filed: Dec. 8, 2025

(30) Foreign Application Priority Data
Dec. 30, 2024 (CN) 202411973668.4

(51) Int. Cl. H04L 9/08; H04L 9/30

(52) U.S. Cl. CPC H04L 9/0825; H04L 9/0838; H04L 9/0869; H04L 9/30

(57) ABSTRACT

Provided are system and method for encrypted communication. First sub-terminal transmits user data of current user to second sub-terminal to generate first key, and generates user public-private key pair according to public key algorithm; second sub-terminal transmits user public key to data processing server, and performs segmentation, splicing, and encryption processing on requests based on service serial number and first key; data processing server, after receiving processed messages of all users in first group, performs merging computation and decryption, restores requests according to service serial number and sends it, and receives response messages; each response message is encrypted using user public key corresponding to service serial number and is stored; second sub-terminal sends query request, obtains all encrypted response messages, attempts decryption using user private key, and determines corresponding response messages based on successfully decrypted messages.

### CROSS REFERENCE TO THE RELATED APPLICATION

The present disclosure claims the priority to the Chinese patent application with the filing No. 202411973668.4 filed with the China National Intellectual Property Administration on Dec. 30, 2024, and entitled “SYSTEM AND METHOD FOR ENCRYPTED COMMUNICATION”, which is incorporated herein by reference in entirety.

### TECHNICAL FIELD

The present disclosure relates to the technical field of data processing, and particularly relates to a system and a method for encrypted communication.

### BACKGROUND

With the development of networks and Internet applications, people are increasingly concerned about the leakage of personal privacy, especially in applications such as electronic payment, electronic voting, and Internet of Vehicles. The insufficient protection of private information often potentially hides many significant unsafe factors, threatening personal property and life safety. Various service systems also provide multiple security means in design, among which the encryption communication technology plays the most core role in information security. However, the current encrypted communication systems mainly focus on confidentiality, non-repudiation, identity authentication, and integrity, but lack comprehensive protection for metadata, particularly for information such as network addresses and user behaviors, resulting in obvious vulnerability of current information network systems when facing attack situation, such as large-scale monitoring, information system vulnerability attacks, and internal malicious administrator attacks.

### SUMMARY

The objective of the present disclosure is to provide a system and a method for encrypted communication to improve the security of the encrypted communication system.

An encrypted communication system is provided in the present disclosure, wherein the system includes: a plurality of user terminals, a registration/logout server, a data processing server, and a database server; and each user terminal includes: a first sub-terminal and a second sub-terminal; network addresses corresponding to the first sub-terminal and the second sub-terminal are different; for each user terminal, the first sub-terminal is configured to send first instruction information to the registration/logout server; the first instruction information is registration request information or logout request information; the registration/logout server is configured to determine a first group corresponding to a current user according to the first instruction information, send the number of users in the first group to the corresponding data processing server, determine user data corresponding to the current user through the first sub-terminal, and transfer, by the first sub-terminal, the user data to the second sub-terminal; the user data comprises a service serial number corresponding to the current user and a plurality of shared keys respectively corresponding to the current user and each other first user in the first group; the second sub-terminal is configured to generate a first key corresponding to the current user based on the plurality of shared keys and a preset first prime number, generate a user public key and a user private key corresponding to the current user based on a preset public key algorithm, send the user public key to the data processing server based on the service serial number and the first key, perform segmentation, splicing, and encryption processing on a request to be processed based on the service serial number and the first key, and send the processed message to the data processing server; the data processing server is configured to perform merging computation and decryption processing on the received processed messages respectively corresponding to all users in the first group based on the number of users, perform data splicing recovery based on the service serial number to obtain recovered requests to be processed respectively sent by each user in the first group, forward each recovered request to be processed, and receive response messages respectively corresponding to each recovered request to be processed, perform encryption processing respectively on each response message by using the user public key corresponding to the service serial number to obtain each encrypted response message, and store each encrypted response message in the database server; and the second sub-terminal is configured to send a query request to the database server to obtain each encrypted response message from the database server, and perform attempted decryption respectively on each encrypted response message based on the user private key corresponding to the current user, and obtain a response message corresponding to the second sub-terminal based on a successfully decrypted message.

Further, for each user terminal, the first sub-terminal of the user terminal is configured to generate a first random number and take the first random number as a first private key of the current user, and calculate a first public key corresponding to the current user according to the first private key and a preset initialization prime number; the first sub-terminal is configured to send the first instruction information to the registration/logout server, wherein if the first instruction information is registration request information, the registration request information comprises a registration instruction and the first public key corresponding to the current user; and if the first instruction information is logout request information, the logout request information comprises a logout instruction and the first public key corresponding to the current user; the registration/logout server is configured to determine the first group corresponding to the current user according to the first instruction information, and send a second public key corresponding to each of the other first users in the first group to the first sub-terminal; and the first sub-terminal is configured to calculate a plurality of shared keys respectively corresponding to the current user and each of the other first users in the first group based on the first private key of the current user, the second public key corresponding to each of the other first users in the first group, and the preset initialization prime number.

Further, the registration/logout server is configured to, when the first instruction information is registration request information, determine whether user information of other users exists in the registration/logout server; record, when the number of other users is less than two, the first public key corresponding to the current user, determine a user group and a group number corresponding to the user group corresponding to the current user and other users, and a user number corresponding to each user in the user group; and generate a new user group when the number of other users is not less than two, and when the number of users in a last user group is greater than a preset number threshold. The preset number threshold is a preset user group threshold plus one, and the new user group includes: users whose user numbers in the last user group are greater than or equal to the user group threshold, and the current user. Different user groups correspond to data processing servers having different addresses and/or ports, and correspond to database servers having different addresses and/or ports; and each user in the same user group corresponds to a data processing server having the same address and port, and a database server having the same address and port.

Further, the first sub-terminal is further configured to calculate an initialization key corresponding to the current user based on the plurality of shared keys in the first group, preset first group common information, and the preset first prime number; and the first sub-terminal is configured to generate a second random number, take the second random number as an index serial number, query a preset prime number table to obtain a corresponding first sub-prime number, calculate a first ciphertext corresponding to the current user based on the first sub-prime number, second group common information, and the initialization key, and send the first ciphertext to the registration/logout server.

Further, the registration/logout server is configured to calculate a first result according to a received first ciphertext respectively corresponding to each user in the first group, and the preset first prime number; the registration/logout server is configured to, for each prime number in the preset prime number table, determine whether the prime number is a factor of the first result; obtain, when the prime number is a factor of the first result, a serial number corresponding to the prime number; sort the obtained multiple serial numbers in ascending order to obtain an ordered list; and send the ordered list to the first sub-terminal to enable the current user to determine a service serial number corresponding to the current user according to the serial number of the second random number in the ordered list.

Further, the second sub-terminal is configured to convert a request to be processed into a bit string, and segment the bit string according to a preset length to obtain a plurality of segmented blocks, wherein the preset length is a difference between a preset message block length and a bit length corresponding to a preset number threshold; sequentially splice each segmented block with the service serial number to obtain spliced blocks, wherein the service serial number is positioned in the most significant bits of the spliced block; determine a block sequence based on each spliced block, take a first spliced block in the block sequence as a current spliced block, and fill the current spliced block into a preset message register; match a corresponding second sub-prime number from the preset prime number table according to a value of the message register; calculate a second ciphertext corresponding to the current spliced block based on the second sub-prime number, a value of a preset counter, the first key, and the preset first prime number; send the second ciphertext to the data processing server, and update the value of the counter; and take a next spliced block in the block sequence as a new current spliced block, and repeatedly perform a step of filling the current spliced block into the preset message register until the second ciphertext corresponding to a last spliced block in the block sequence is sent to the data processing server.

Further, the second sub-terminal is also configured to periodically obtain a value in the preset message register, and match a corresponding third sub-prime number from the preset prime number table according to the value of the message register; calculate a third ciphertext based on the third sub-prime number, the value of a preset counter, the first key, and the preset first prime number; send the third ciphertext to the data processing server; update the value of the counter; and when no request to be processed exists, generate a third random number, splice the third random number to the service serial number to obtain a splicing result, fill the splicing result into the preset message register, and repeatedly perform the step of periodically obtaining the value in the preset message register.

Further, the data processing server is configured to receive a target ciphertext according to an address of the second sub-terminal, store the target ciphertext into a corresponding ciphertext block queue in sequence according to the address, and calculate a second result each time according to target ciphertexts at the same position in each ciphertext block queue and the first prime number, wherein the target ciphertext is the second ciphertext or the third ciphertext; the data processing server is configured to determine, for each prime number in the preset prime number table, whether the prime number is a factor of the second result, and obtain a serial number corresponding to the prime number when the prime number is a factor of the second result; and the data processing server is configured to obtain a decryption result set according to the obtained multiple serial numbers, exclude the third random number from the decryption result set according to the service serial number, and recover a recovered request to be processed corresponding to the service serial number.

Further, the data processing server is in communication connection with a preset service server; the data processing server is configured to send each recovered request to be processed to the service server, and receive a response message corresponding to each recovered request to be processed returned by the service server; and determine a user public key respectively corresponding to each service serial number according to the service serial number corresponding to each recovered request to be processed, so as to perform encryption processing respectively on each response message by using each user public key to obtain each encrypted response message.

Further, the second sub-terminal is configured to periodically send a query request to the database server; the database server is configured to establish a message queue corresponding to the second sub-terminal according to a network address corresponding to the second sub-terminal, store each encrypted response message into the message queue, package all encrypted response messages in the message queue, and return the packaged messages to the second sub-terminal; and the second sub-terminal is configured to perform attempt decryption on the packaged messages by using a user private key corresponding to the current user, and obtain a response message corresponding to the second sub-terminal based on a successfully decrypted message.

A method for encrypted communication is provided in the present disclosure, and the method includes: the first sub-terminal sending first instruction information to the registration/logout server for each user terminal, wherein the first instruction information is registration request information or logout request information; the registration/logout server determining a first group corresponding to a current user according to the first instruction information, sending the number of users in the first group to the corresponding data processing server, determining user data corresponding to the current user through the first sub-terminal, and transferring, by the first sub-terminal, the user data to the second sub-terminal, wherein the user data comprises a service serial number corresponding to the current user and a plurality of shared keys respectively corresponding to the current user and each other first user in the first group; the second sub-terminal generating a first key corresponding to the current user based on the plurality of shared keys and a preset first prime number, generating a user public key and a user private key corresponding to the current user based on a preset public key algorithm, sending the user public key to the data processing server based on the service serial number and the first key, performing segmentation, splicing, and encryption processing on a request to be processed based on the service serial number and the first key, and sending the processed message to the data processing server; the data processing server performing merging computation and decryption processing on the received processed messages respectively corresponding to all users in the first group based on the number of users, performing data splicing recovery based on the service serial number to obtain recovered requests to be processed respectively sent by each user in the first group, forwarding each recovered request to be processed, and receiving response messages respectively corresponding to each recovered request to be processed, performing encryption processing respectively on each response message by using the user public key corresponding to the service serial number to obtain each encrypted response message, and storing each encrypted response message in the database server; and the second sub-terminal sending a query request to the database server to obtain each encrypted response message from the database server, and performing attempted decryption respectively on each encrypted response message based on the user private key corresponding to the current user, and obtaining a response message corresponding to the second sub-terminal based on a successfully decrypted message.

In the system and method for encrypted communication provided in the present disclosure, the first sub-terminal is configured to send first instruction information to the registration/logout server for each user terminal, wherein the first instruction information is registration request information or logout request information; the registration/logout server is configured to determine a first group corresponding to a current user according to the first instruction information, send the number of users in the first group to the corresponding data processing server, determine user data corresponding to the current user through the first sub-terminal, and transfer, by the first sub-terminal, the user data to the second sub-terminal; the user data comprises a service serial number corresponding to the current user and a plurality of shared keys respectively corresponding to the current user and each other first user in the first group; the second sub-terminal is configured to generate a first key corresponding to the current user based on the plurality of shared keys and a preset first prime number, generate a user public key and a user private key corresponding to the current user based on a preset public key algorithm, send the user public key to the data processing server based on the service serial number and the first key, perform segmentation, splicing, and encryption processing on a request to be processed based on the service serial number and the first key, and send the processed message to the data processing server; the data processing server is configured to perform merging computation and decryption processing on the received processed messages respectively corresponding to all users in the first group based on the number of users, perform data splicing recovery based on the service serial number to obtain recovered requests to be processed respectively sent by each user in the first group, forward each recovered request to be processed, and receive response messages respectively corresponding to each recovered request to be processed, perform encryption processing respectively on each response message by using the user public key corresponding to the service serial number to obtain each encrypted response message, and store each encrypted response message in the database server; and the second sub-terminal is configured to send a query request to the database server to obtain each encrypted response message from the database server, and perform attempted decryption respectively on each encrypted response message based on the user private key corresponding to the current user, and obtain a response message corresponding to the second sub-terminal based on a successfully decrypted message. The system can realize protection by obfuscation of user communication metadata, thereby improving the security of the encrypted communication system.

### BRIEF DESCRIPTION OF DRAWINGS

In order to more clearly illustrate the specific embodiments of the present invention or the technical solution in the prior art, the drawings required to be used in the description of the specific embodiment or prior art will be briefly introduced as follows. Obviously, the drawings described below are some embodiments of the present disclosure, and for those of ordinary skill in the art, without paying creative labor, may also obtain other drawings according to these drawings.

FIG. 1 is a schematic diagram of a principle of a typical encrypted communication system in related technology;

FIG. 2 is a schematic diagram of a basic architecture of an application system in related technology;

FIG. 3 is a schematic diagram of a typical attack on an encrypted system in related technology;

FIG. 4 is a schematic diagram of an encrypted communication system provided in an embodiment of the present disclosure;

FIG. 5 is a schematic diagram of an encrypted communication system provided in an embodiment of the present disclosure;

FIG. 6 is a schematic diagram of an operation flow of an encrypted communication system provided in an embodiment of the present disclosure;

FIG. 7 is a schematic diagram of a user registration/logout process provided in an embodiment of the present disclosure;

FIG. 8 is a schematic diagram of one-way message transmission provided in an embodiment of the present disclosure;

FIG. 9 is a schematic diagram of a private information query process provided in an embodiment of the present disclosure; and

FIG. 10 is a flowchart of an encrypted communication method provided in an embodiment of the present disclosure.

### DETAILED DESCRIPTION OF EMBODIMENTS

The technical solutions of the present disclosure will be clearly and completely described below in connection with the embodiments. Obviously, the described embodiments are a part of the embodiments of the present disclosure and not all of the embodiments. Based on the embodiments of the present disclosure, all other embodiments obtained by those of ordinary skill in the art without making inventive efforts are within the scope of protection of the present disclosure.

With the development of networks and Internet applications, people are increasingly concerned about the leakage of personal privacy, especially in applications such as electronic payment, electronic voting, and Internet of Vehicles. The insufficient protection of private information often potentially hides many significant unsafe factors, threatening personal property and life safety. For example, on an electronic payment server controlled by a bank, related information such as account property, identity, communication, and account transactions associated with a network address of a user can be collected. Once such information is obtained by an illegal organization that has invaded the bank, it will become an entry point for financial fraud and network attacks initiated based on the network address, serving as a fuse threatening property security. As another example, in a vehicle networking application, if a vehicle networking server controlled by an automobile manufacturer is invaded by an illegal organization, the organization may obtain vehicle information and communication network address information of a specific user through the server, and then perform remote control targeting the vehicle network address information of the specific user to cause a car accident. Various service systems, while providing convenience, have also become potential major threats to property safety and personal safety in the information age.

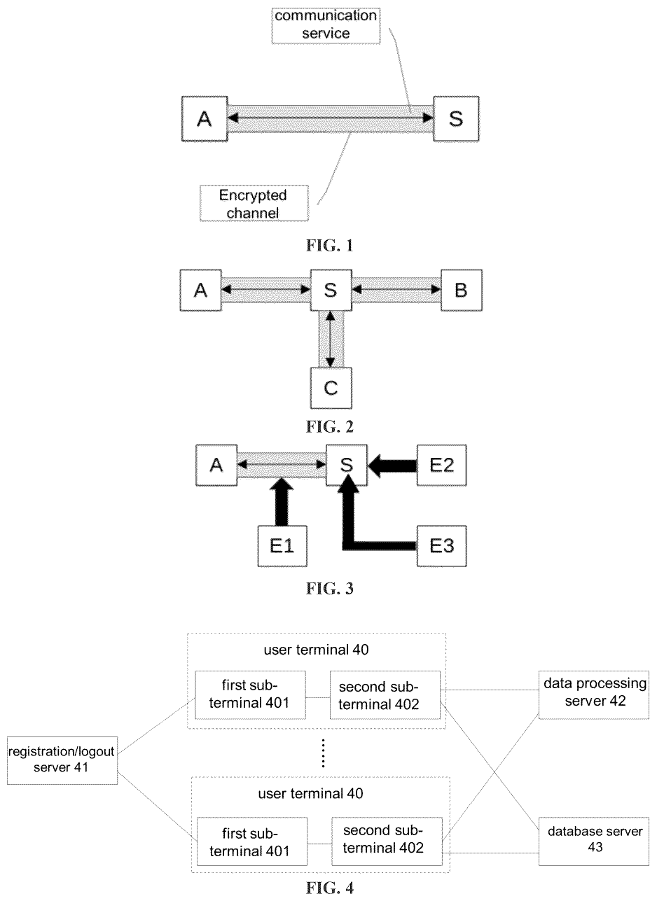

Various service systems also provide multiple security means in design, among which the encryption communication technology plays the most core role in information security. As shown in FIG. 1, which is a schematic diagram of a principle of a typical encrypted communication system, A and S perform communication in the figure. To avoid direct interception of communication service content, A and S can construct an encrypted channel through a symmetric encryption algorithm or a public key encryption algorithm with pre-distributed keys, and then encapsulate and transmit communication services within the encrypted channel. A typical encrypted communication system realizes confidentiality of information transmission, non-repudiation of communication parties, and user identity authentication, and ensures message integrity through message verification. Confidentiality, non-repudiation, identity authentication, and integrity are the main functions usually realized by encrypted communication systems. A typical encryption encapsulation and message decryption process can be simplified as:

C=Enc(K,M),M=Dec(K,C),

where M is a plaintext message to be transmitted, K is an encryption key shared by both parties, and Enc is a symmetric encryption algorithm. C is the ciphertext calculated by one party, which encapsulates the network addresses of the sender and the receiver, and is then transmitted to the other party according to the network addresses. The other party restores M by using a decryption algorithm Dec and the shared key K, thereby completing one message transmission. For a system adopting a public key encryption algorithm, a pair of pre-generated public and private keys (K_{pub}, Kₚᵣᵢ) can be used.

During encrypted communication, both messages from A and S include the sender address, the receiver address, and the ciphertext M transmitted to the other party. As long as it is detected that ciphertexts exist in the communication channel, it can be known which addresses have performed encrypted communication. By continuously observing the sending time and length of the ciphertext, and the like, an association with the behaviors of parties can be established.

Based on the above encrypted communication system principle, a basic architecture of an application system can be constructed as shown in FIG. 2, in which S is a service server, and A, B, and C are user terminals of the service system. A, B, and C interact with S, respectively, to establish encrypted channels for communication. Typical examples include HTTPS (hypertext transfer protocol secure) websites, bank online payments, vehicle networking applications, and social applications built on this basis. Typical applications can also adopt multi-layer nested encrypted communication systems.

Metadata refers to information describing communication characteristics and attributes, including communication address, communication time, communication frequency, communication duration, message length, and the like, and normally does not contain the actual content of communication. On one hand, metadata can be used in network management to help monitor network traffic and diagnose network problems; on the other hand, metadata can be used to track user behavior and determine patterns of target activities. Corresponding to the large-scale application of information security technologies that take encrypted communication technology as the core, targeted attack techniques are also continuously developing. Collection of user privacy information based on metadata can, without breaking the encrypted communication system, further perform statistical analysis and mining of specific user behavior on the basis of collected metadata, thereby associating encrypted communication with user behavior to achieve the purpose of collecting user privacy information. Therefore, the current focus of encrypted communication systems on confidentiality, non-repudiation, identity authentication, and integrity alone is insufficient, and the lack of protection technology for metadata has become a typical security problem that urgently needs to be solved now.

Currently, the main attack methods by which attackers use metadata to implement user privacy information theft and collection can generally be classified into three types: large-scale network monitoring, exploitation of information system vulnerabilities, and theft by internal malicious administrators. As shown in FIG. 3, which is a schematic diagram of a typical attack on an encrypted system, E1 represents a large-scale network eavesdropper, E2 represents a hacker organization that exploits information system vulnerabilities to perform system intrusion, and E3 represents a malicious administrator who has entered into the inside of the service system. Below, three typical attack methods are respectively described, and the difficulty of existing encrypted communication systems in defending against behavior analysis attacks that utilize metadata, and possible user privacy leakage, and more serious consequences, are discussed.
(1) Large-scale monitoring exists in networks. Based on disclosed public information, governments of various countries, network operators, cloud service providers, and community mobile communication base stations all in fact possess the capability to monitor encrypted communication channels. Although a listener E1 may not be able to break the encrypted channel to directly obtain confidential information transmitted in the channel, E1 may employ technical means similar to encrypted channel behavior identification, and based on bidirectional encrypted channel communication information between A and S, reveal statistical patterns of communication from A to S, thereby matching to specific service behaviors carried within, and E1 may further match network addresses to real-world physical addresses to give a more detailed portrait of the real user.

For example, address S is an online banking service system. Since this system is public, any account holder may log in. If an attacker, through studying communication patterns of the system, discovers that information sent to account holders with large assets differs from that sent to ordinary account holders, the attacker may further utilize this feature to identify, through statistical analysis of interaction data amount and interaction frequency between the user address and the bank address in the encrypted channel, that a certain network address corresponds to an account holder possessing large assets, even without decryption. This network address may then become a target for further network attacks.

The encrypted channel behavior analysis attack method, based on connection time, number of communications, amount of communication data, and the like occurring between network addresses of bidirectional interaction, can, without intruding into the encrypted system or the encrypted channel, identify network address information engaged in encrypted communication by using statistical characteristics and known information, and further use telecommunication operator data to trace from the network address to a physical address, thereby extending the network attack to the real world.
(2) Exploitable vulnerabilities exist in information network systems. Given that security incidents occur frequently at present, most information network systems may face such risks. A typical security incident is the Log4J vulnerability in 2021, which caused massive risks of intrusion for numerous network service systems worldwide, including financial institutions and government websites, and whether these were intruded upon and caused leakage of large amounts of user information can no longer be traced.

Using the model shown in FIG. 3, E2 represents an attacker capable of intruding into information systems. In the worst case, E2 can control S and analyze historical records in S, thereby locating and tracking network addresses of user A and revealing daily behaviors corresponding to the network address of user A.

Taking a multilayer nested VPN (virtual private network) system as a specific example, A may not reveal its real network address to S, but if E2 controls S, based on the interaction between A and S, E2 only needs to insert into the information returned from S to A certain channel characteristics based on bidirectional interaction, such as time, duration, communication volume, and the like, to conspire with E1 in tracing and locating the real network address of A, and further, in conjunction with telecommunication operator data, trace to the real-world individual.
(3) Malicious administrators exist in service systems. A typical incident is that a department may order a company to hand over data of certain users stored on its servers, in which case the company becomes a malicious administrator toward any user using the service system of the company, and all users thereon may be infringed. Specifically, a malicious administrator E3 can conspire with E2 and E1 to achieve comprehensive control over the service system. Without destroying information integrity, encrypted channel confidentiality, user identity authentication, or user non-repudiation between A and S, E3 can continuously monitor communication content of address A and associate address A with telecommunication operator databases to locate the individual in the real world. Although in some cases this may be legitimate from an administrative perspective, it seriously infringes on user privacy. In certain extreme cases, a malicious administrator may harm the personal life and property safety of each user by the same means.

Another typical example is that a network management staff member within a banking group may access log records of the business system of a bank, thereby discovering that an address frequently accessed corresponds to a user with net assets exceeding one hundred million, and may then conspire with a hacker organization to perform network attacks and fraud on the network address of the user.

In summary, the current encrypted communication systems mainly focus on confidentiality, non-repudiation, identity authentication, and integrity, and lack comprehensive protection for metadata, particularly for information such as network addresses and user behaviors, resulting in obvious vulnerability of current information network systems when facing attack situation, such as large-scale monitoring, information system vulnerability attacks, and internal malicious administrator attacks, and making it difficult to provide effective protection. Based on this, embodiments of the present disclosure provide a system and a method for encrypted communication, which can be applied in application scenarios requiring encrypted communication.

For ease of understanding of the present embodiment, an encrypted communication system disclosed in the embodiments of the present disclosure is first introduced. As shown in FIG. 4, the system includes: a plurality of user terminals 40, a registration/logout server 41, a data processing server 42, and a database server 43. Each user terminal 40 includes a first sub-terminal 401 and a second sub-terminal 402, network addresses corresponding to the first sub-terminal 401 and the second sub-terminal 402 are different, and each user terminal 40 can be divided into two parts, namely the first sub-terminal 401 and the second sub-terminal 402. The first sub-terminal 401 is mainly configured for user registration, logout, and group query, and does not involve any service information. The first sub-terminal 401 can also be referred to as a registration terminal, and the network address used is referred to as a registration address. The second sub-terminal 402 is mainly configured for sending and receiving service data; and the second sub-terminal 402 can also be referred to as a service terminal, and the network address used is referred to as a service address.

The first sub-terminal 401 is configured to send first instruction information to the registration/logout server 41 for each user terminal 40, wherein the first instruction information is registration request information or logout request information. In actual implementation, a user can use the registration address corresponding to the first sub-terminal 401 to access a registration/logout server 41, and submit registration request information such as a certificate and a registration instruction for registration; alternatively, the user can use the registration address corresponding to the first sub-terminal 401 to access the registration/logout server 41, and submit logout request information such as a certificate and a logout instruction for logout.

The registration/logout server 41 is configured to determine a first group corresponding to a current user according to the first instruction information, send the number of users in the first group to the corresponding data processing server 42, determine user data corresponding to the current user through the first sub-terminal 401, and transfer, by the first sub-terminal, the user data to the second sub-terminal 402. The user data comprises a service serial number YWid corresponding to the current user and a plurality of shared keys respectively corresponding to the current user and each other first user in the first group.

The above service serial number YWid can be used to identify a current user, and different users correspond to different service serial numbers; that is, there is a one-to-one correspondence between the user and the service serial number. The above shared key is usually determined based on the user private key of the current user and the second public key of each first user in a first group, and according to a preset calculation manner, the user private key is respectively calculated with the second public key of each first user to obtain multiple shared keys respectively corresponding to the current user and each of the other first users. In actual implementation, the registration/logout server 41 usually receives instruction information sent by multiple users. Therefore, after receiving the first instruction information sent by the current user, the registration/logout server 41 can group the current user with other users to determine a first group corresponding to the current user, and can send the number of users in the first group to a corresponding data processing server 42. The first sub-terminal 401 can further determine a service serial number YWid corresponding to a current user, and the plurality of shared keys respectively corresponding to the current user and each of the other first users in the first group; and send the information to a corresponding second sub-terminal 402.

The second sub-terminal 402 is configured to generate a first key Sᵢ corresponding to the current user based on the plurality of shared keys and a preset first prime number P, generate a user public key pubKeyᵢ and a user private key priKeyᵢ corresponding to the current user based on a preset public key algorithm, send the user public key pubKeyᵢ to the data processing server 42 based on the service serial number YWid and the first key Sᵢ, perform segmentation, splicing, and encryption processing on a request to be processed based on the service serial number YWid and the first key Sᵢ, and send the processed message to the data processing server 42.

The above public key algorithm can be implemented by adopting an RSA algorithm (an asymmetric encryption algorithm) and the like; in actual implementation, the second sub-terminal can perform corresponding calculation with a preset first prime number P based on multiple shared keys received, so as to generate a first key Sᵢ corresponding to the current user. A public key algorithm, such as the RSA algorithm, can also be adopted to generate a user public key pubKeyᵢ and a user private key priKeyᵢ. Before sending a request to be processed to a data processing server 42, the user public key pubKeyᵢ is usually sent to the data processing server 42 based on the service serial number YWid and the first key Sᵢ. Then, the request to be processed is subjected to segmentation, splicing, and encryption processing based on the service serial number YWid and the first key Sᵢ to obtain a processed message, which is sent to the data processing server 42. The processed message is usually multiple encrypted spliced blocks corresponding to the request to be processed.

The data processing server 42 is configured to perform merging computation and decryption processing on the received processed messages respectively corresponding to all users in the first group based on the number of users, perform data splicing recovery based on the service serial number YWid to obtain recovered requests to be processed respectively sent by each user in the first group, forward each recovered request to be processed, and receive response messages respectively corresponding to each recovered request to be processed, perform encryption processing respectively on each response message by using the user public key pubKeyᵢ corresponding to the service serial number YWid to obtain each encrypted response message, and store each encrypted response message in the database server 43.

In actual implementation, since the data processing server 42 receives processed messages respectively corresponding to all users in the first group, and each processed message corresponding to each user is usually multiple encrypted spliced blocks, the received-and-processed messages need to be combined, decrypted, and concatenated according to the service serial number YWid for data belonging to the same service serial number, so as to recover a recovered request to be processed respectively corresponding to each user in the first group. Each recovered request to be processed can be sent to a service server connected thereto, and the response message corresponding to each recovered request to be processed returned by the service server is received. A user public key corresponding to each service serial number is selected to encrypt each received response message, and each encrypted response message is sent to a database server 43 for storage.

The second sub-terminal 402 is configured to send a query request to the database server 43 to obtain each encrypted response message from the database server 43, and perform attempted decryption respectively on each encrypted response message based on the user private key priKeyᵢ corresponding to the current user, and obtain a response message corresponding to the second sub-terminal based on a successfully decrypted message.

The second sub-terminal 402 can periodically send a query request to the database server 43 to request the latest messages in the database server 43. After receiving the query request, the database server 43 can return each encrypted response message to the second sub-terminal 402. The second sub-terminal 402 attempts to decrypt each encrypted response message based on the user private key priKeyᵢ of the current user. Since each encrypted response message received by the second sub-terminal 402 includes not only the response message required by itself but also response messages required by other users in the first group, the second sub-terminal 402 can successfully decrypt only the response message required by itself using the user private key priKeyᵢ, and fails to decrypt response messages corresponding to other users. Finally, the successfully decrypted message can be treated as the response message belonging to the second sub-terminal 402.

For ease of understanding, FIG. 5 shows a schematic diagram of an encrypted communication system. The system adds three parts—RegS (corresponding to the above registration/logout server), Agent (corresponding to the above data processing server), and DB (database, corresponding to the above database server)—on the basis of the original star-type encryption system structure. S still represents the original service server and remains unchanged. The figure includes three user terminals, each divided into two parts. One part, such as A, B, and C in the figure, is still used for sending and receiving service data, and the terminal used is referred to as a service terminal (corresponding to the above second sub-terminal), and the network address used is a service address. The other part, such as A′, B′, and C′ in the figure, is used for user registration, logout, group query, and the like, and does not involve any service information. The terminal used is referred to as a registration terminal (corresponding to the above registration terminal), and the network address used is a registration address.
\textcircled{1} in FIG. 5 represents a first stage, referred to as a user registration/logout stage. A user accesses RegS using the registration address to submit a certificate and a registration instruction for registration, or the user accesses RegS using the registration address to submit a certificate and a logout instruction for logout. RegS, according to an actual number of users and a grouping threshold, sets user grouping and information of Agent and DB corresponding to each group, and provides the public key information of users within the group to each user in the group.
\textcircled{2} in FIG. 5 represents a second stage, referred to as an initialization stage. The user interacts with RegS using the registration address, and after the interaction, RegS also synchronizes the interaction result to Agent, thereby completing initialization of system key information.
\textcircled{3} in FIG. 5 represents a third stage, referred to as a unidirectional sending stage. The user uses the service address to send, to S, a request to be processed, which is subjected to operations such as partitioning, encapsulating, and encrypting, and sends the request to be processed unidirectionally to the Agent.
\textcircled{4} in FIG. 5 represents a fourth stage, referred to as an aggregation calculation stage. Agent receives each ciphertext block unidirectionally sent by each user, and extracts synchronized ciphertext blocks sequentially for merging calculation and decryption of information.
\textcircled{5} in FIG. 5 represents a fifth stage, referred to as a request restoration stage. Agent assembles each block information sent by each user to restore the original to-be-processed request sent to S by the user.
\textcircled{6} in FIG. 5 represents a sixth stage, referred to as a simulated communication stage. Agent simulates the user, sends the restored request to be processed to S, and receives a response message returned from S.
\textcircled{7} in FIG. 5 represents a seventh stage, referred to as a response storage stage. Agent processes the response message returned from S and sends it to DB for storage.
\textcircled{8} in FIG. 5 represents an eighth stage, referred to as a privacy query stage. The user uses the service address to initiate a query for the latest response message to DB, and after decryption respectively obtains the response message corresponding to S.

As shown in FIG. 6, a schematic diagram of an operation process of an encrypted communication system illustrates the operation processes of the eight main stages of the system. Whenever a user registers or logs out, initialization needs to be performed. Under normal communication, each time the user terminal and the S server communicate, it is in a request/response manner. Each request message sending starts from the unidirectional sending stage, and goes through aggregation calculation, request restoration, simulated communication, result storage, and privacy sending, and finally, the user terminal receives the response message of S, thereby completing an entire communication loop. From the unidirectional sending to the aggregation calculation, regardless of whether a user has an actual message to send, the process is executed periodically. That is, each user performs data encryption and sending actions periodically and simultaneously in a unidirectional manner. Agent performs batch aggregation calculation, completes decryption, and extracts and restores request information. If the aggregation calculation of Agent fails, it indicates that the unidirectional sending has lost synchronization. In this case, the user group is disbanded, resources are reclaimed, and all users re-register.

The above encrypted communication system can realize protection by obfuscation of user communication metadata, thereby improving the security of the encrypted communication system. The system protects user communication metadata information, including metadata information such as service communication time, service duration, and service data volume, so as to realize that user address and user service communication information are uncorrelated, thereby preventing attackers from using metadata to analyze user behavior, collect user privacy, or locate user positions.

Further, for each user terminal, the first sub-terminal of the user terminal is configured to generate a first random number and take the first random number as a first private key InitXᵢ of the current user, and calculate a first public key InitYᵢ corresponding to the current user according to the first private key InitXᵢ and a preset initialization prime number InitP.

The following first describes a method for setting some key parameters of the system.

The user group threshold set by the system is yN, and the user group threshold is the maximum number of users in each group.

A preset first prime number used by the system for message encryption is P, and the bit length is LenP.

A preset initialization prime number used by the system for initialization is InitP.

The message block length of the system is L bits.

A preset prime number table PT is arranged in the system, and prime numbers 2, 3, 5 . . . in natural numbers are sequentially filled, with a total number of 2^{L}.

The bit length of the last prime number in the preset prime number table PT is LLast. Then yN should be less than LenP/LLast, and the bit length of yN should be less than L divided by 2.

If the preset first prime number P used for message encryption has a 1024-bit length, L is 24, and it is estimated that the length of LLast is less than 30 bits, then yN can be set between [3, 34].

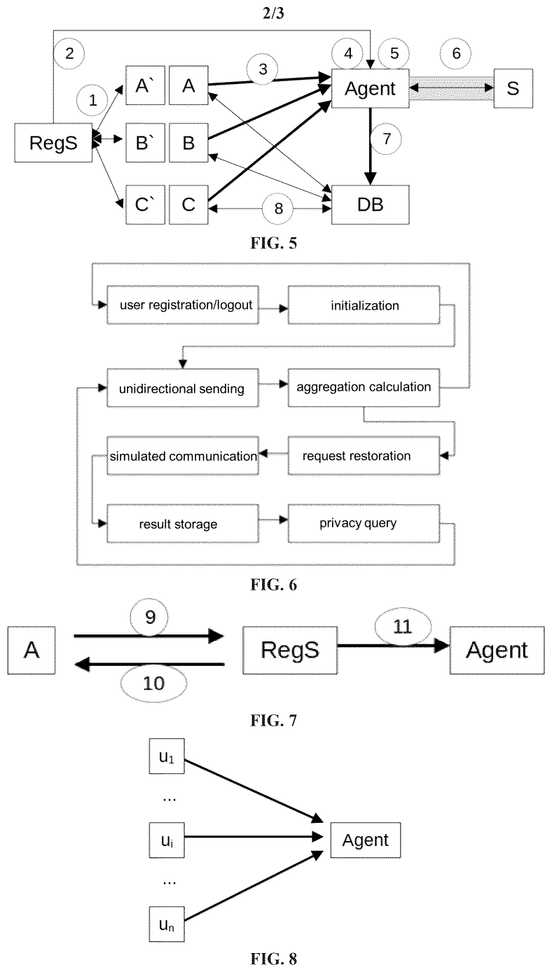

The above preset initialization prime number InitP is a prime number selected by the system, generally selected with a length of 2048 bits. Similarly, the length of InitXᵢ should be consistent with that of InitP. As shown in FIG. 7, which is a schematic diagram of a user registration/logout process, in actual implementation, \textcircled{9} in FIG. 7 represents a user information submission sub-stage in the process. In the sub-stage, the first sub-terminal of each user independently generates a first random number InitXᵢ, and calculates a first public key InitYᵢ based on the preset initialization prime number InitP. Specifically, the first public key InitYᵢ can be calculated according to the following calculation formula:

$${InitY}_{i} = {2}^{{InitX}_{i}} mod InitP ,$$

where “mod” represents a modulo operation, that is, a remainder operation.

Each user stores a corresponding pair (InitXᵢ, InitYᵢ).

The first sub-terminal is configured to send the first instruction information to the registration/logout server, wherein if the first instruction information is registration request information, the registration request information comprises a registration instruction and the first public key InitYᵢ corresponding to the current user; and if the first instruction information is logout request information, the logout request information comprises a logout instruction and the first public key InitYᵢ corresponding to the current user.

When the current user needs to register, a registration request message can be submitted to the registration/logout server through the first sub-terminal, wherein the registration request message can include a registration instruction and InitYᵢ. When the current user needs to log out, a logout request message can be submitted to the registration/logout server through the first sub-terminal, wherein the logout request message can include a logout instruction and InitYᵢ. The registration instruction and the logout instruction can also be represented by letters, numbers, or identifiers.

The registration/logout server is configured to determine the first group corresponding to the current user according to the first instruction information, and send a second public key corresponding to each of the other first users in the first group to the first sub-terminal.

The first sub-terminal is configured to calculate a plurality of shared keys InitKᵢⱼ respectively corresponding to the current user and each of the other first users in the first group based on the first private key InitXᵢ of the current user, the second public key corresponding to each of the other first users in the first group, and the preset initialization prime number InitP.

In actual implementation, the registration/logout server can determine a first group to which the current user belongs according to the first instruction information. Each of the other first users in the first group can determine a corresponding second public key in the manner described above. The registration/logout server can send the second public key corresponding to each first user to the first sub-terminal of the current user. For example, the registration/logout server can publicly release updated group information through a Web service provided by the registration/logout server, such that the current user can access a Web server page in time. Based on the submitted first public key InitYᵢ, the current user queries the first group to which the user belongs, and the second public keys corresponding to each of the other first users in the first group; and the current user downloads all second public keys of the first users in the first group to a local terminal.

After the current user learns the first group to which the user belongs, assuming that the number of users in the first group is n, each user in the first group reconstructs a service sequence number by using the following sequencing algorithm. First, a shared key InitKᵢⱼ needs to be calculated. Specifically, the current user i can calculate the shared key InitKᵢⱼ based on the first private key InitXᵢ of the user and the second public key InitYⱼ of another first user j (j≠i) in the group. The shared key InitKᵢⱼ can be calculated according to the following formula:

$${InitK}_{ij} = {{InitY}_{j}}^{{InitX}_{i}} mod InitP .$$

Further, the registration/logout server is configured to, when the first instruction information is registration request information, determine whether user information of other users exists in the registration/logout server; record, when the number of other users is less than two, the first public key InitYᵢ corresponding to the current user, determine a user group and a group number corresponding to the user group corresponding to the current user and other users, and a user number corresponding to each user in the user group; and
generate a new user group when the number of other users is not less than two, and when the number of users in a last user group is greater than a preset number threshold. The preset number threshold is a preset user group threshold plus one, and the new user group includes: users whose user numbers in the last user group are greater than or equal to the user group threshold, and the current user.

Different user groups correspond to data processing servers having different addresses and/or ports, and correspond to database servers having different addresses and/or ports; each user in the same user group corresponds to a data processing server having the same address and port, and a database server having the same address and port.

As shown in FIG. 7, \textcircled{10} is a user grouping phase in the process, which is executed after the registration/logout server receives the first instruction information. If the first instruction information is registration request information, the user grouping can be performed according to the following algorithm.
Step 0: executing only when system resources change or during system initialization. Addresses of Agents and DB resources in the system are numbered starting from 0, and the serial number corresponds to a “groupid”.
Step 1: only registering the public key of the new user when there are no users or fewer than two users in the current RegS system, and assigning the group ID (groupid) and user ID within the group (userid) by starting from 0. After the first user is registered, the RegS system generates a record (0, 0, Agent address and/or port, DB address and/or port), thereby associating the user with Agent and DB resources through the groupid.

If the number of users in the RegS system is greater than or equal to two, proceed to Step 2.
Step 2: creating a new group when the userid of the last record in the current RegS system is greater than (yN+1), and assigning the new group ID by incrementing the groupid of the last record by 1, that is, new groupid is equal to the groupid of the last record+1. In the present embodiment, each group needs to include at least three users. New group members are assigned, including users in the previous group whose user IDs (userid) are greater than or equal to yN, and the corresponding Agent address and DB address are designated. In actual implementation, when the number of users is small, all users can be placed in a single group sharing one Agent and DB. Considering that computing resources are limited in practice, when the number of users is large, users need to be divided into groups to enhance network stability. Different user groups correspond to data processing servers with different addresses and/or ports and database servers with different addresses and/or ports.
Step 3: adding a new data record, when the userid of the last record in the current RegS is not greater than (yN+1), where the groupid equals the groupid of the last record, the userid equals the last userid+1, and the addresses are the same as those of the Agent and DB in the last record.

The registration/logout server is configured to, when the first instruction information is logout request information, perform the following algorithm to update the grouping information.
Step 0: sequentially querying the data records corresponding to registered users in the RegS by starting from (0, 0) according to (groupid, userid), and performing one-by-one matching confirmation with the public key information to be logged out. If no match is found, the subsequent steps are not executed.
Step 1: deleting an entry when a public key information is matched under the (groupid, userid) entry, and adjusting the values of all user IDs (userid) greater than the current entry within the group, and decrementing them by 1 in order.
Step 2: deleting all entries in the group, when, after adjustment, all user IDs (userid) in the current group are less than 2, and requiring re-registration; returning the Agent address and DB address to the end of the address order; and waiting for reassignment. The algorithm provided in this embodiment has a security effect only when the number of users in a group is greater than or equal to three. Therefore, if the number of users is less than or equal to two, that is, if all user IDs in the group are less than 2, the group will be dissolved and cannot perform communication according to the subsequent algorithms. After the group is dissolved, the Agent and DB resources originally corresponding to the group can be reclaimed and reassigned for reuse.

After registration or logout, the updated data records are publicly issued through the Web service provided by RegS.

Further, the first sub-terminal is further configured to calculate an initialization key InitSᵢ corresponding to the current user based on the plurality of shared keys InitKᵢⱼ in the first group, preset first group common information InitInfo1, and the preset first prime number P.

The above-mentioned common information InitInfo1 of the first group can include the groupid, address information of RegS, the Agent address and DB address assigned to the group, or a combination of these common pieces of information, which can be uniformly set by the system. To reconstruct the service serial number, after calculating the above shared keys InitKᵢⱼ, the first sub-terminal can calculate an initialization key InitSᵢ corresponding to the current user based on the plurality of shared keys InitKᵢⱼ in the first group, preset first group common information InitInfo1, and the preset first prime number P, which is calculated by the following formula:

$${InitS}_{i} = {\sum }_{j \neq i} {( - 1 )}^{j > ι} PRF ( {InitK}_{ij} , InitInfo 1 ) mod ( P - 1 ) .$$

The above PRF (pseudo-random function) is a pseudo-random generation algorithm. When j>i, the expression is true, and the value of the expression equals 1; when j<i, the expression is false, and the value of the expression equals 0. It is then substituted into the above formula (−1)^{j>i}; when j>i, the value of the expression equals −1; when j<i, the value of the expression equals 1.

The first sub-terminal is configured to generate a second random number Compᵢ with a bit length less than L, take the second random number Compᵢ as an index serial number, query a preset prime number table PT to obtain a corresponding first sub-prime number Pᵢ₁, calculate a first ciphertext E(Pᵢ₁) corresponding to the current user based on the first sub-prime number Pᵢ₁, second group common information InitInfo2, and the initialization key InitSᵢ, and send the first ciphertext E(Pᵢ₁) to the registration/logout server.

In the above preset prime number table PT, prime numbers 2, 3, 5 . . . in natural numbers are sequentially filled, with a total number of 2^{L}. L corresponds to the message block length of L bits. The first sub-terminal can generate a second random number Compᵢ whose length does not exceed the message block length L bits. Using the second random number Compᵢ as an index serial number, the preset prime number table PT is queried to obtain the corresponding first sub-prime number Pᵢ₁. Based on the second common information InitInfo2, the first ciphertext E(Pᵢ₁) is calculated according to the following formula:

$$E ( {P}_{i 1} ) = {P}_{i 1} \cdot {Hash ( InitInfo2 )}^{{InitS}_{i}} mod P .$$

The second group common information InitInfo2 can include the groupid, the address information of RegS, the addresses of the Agent and DB assigned to the group, and so on. In the embodiment, an example is provided where the first group common information InitInfo1 and the second group common information InitInfo2 are set to be the same. In practice, in specific implementations, the first group common information InitInfo1 and the second group common information InitInfo2 can be completely different in different groups. Typically, these are software built-in settings, which can be publicly available information or information shared within the group. This does not affect subsequent security and is only used for the multi-party collaborative computation process.

Each of the other first users within the first group can calculate their respective first ciphertext in the manner described above.

Further, the registration/logout server is configured to calculate a first result M₁ according to a received first ciphertext respectively corresponding to each user in the first group, and the preset first prime number P. The registration/logout server is configured to, for each prime number in the preset prime number table, determine whether the prime number is a factor of the first result M₁; obtain, when the prime number is a factor of the first result M₁, a serial number corresponding to the prime number; sort the obtained multiple serial numbers in ascending order to obtain an ordered list R; and send the ordered list to the first sub-terminal to enable the current user to determine a service serial number YWid corresponding to the current user according to the serial number of the second random number Compᵢ in the ordered list.

In practice, after the registration/logout server receives the first ciphertexts corresponding to each user in the first group, it can calculate the first result M₁ according to the following formula:

$${M}_{1} = \prod E ( {P}_{i 1} ) mod P .$$

The registration/logout server uses the prime numbers in the preset prime number table PT to compute M₁ one by one, and check whether each prime is a factor of the first result M₁. If so, the serial number corresponding to that prime is taken as a decryption result, and thus a collection of the serial numbers is obtained. The collection of the serial numbers is then sorted in ascending order to obtain an ordered list R as the final decryption result.

If the resulting ordered list R contains n elements (corresponding to the number of users in the first group), RegS publishes this ordered list R on a Web page; otherwise, it is not published.

A user can query the ordered list R published by RegS. If the list is published, the current user i can download the ordered list R and check the serial number of the second random number Compᵢ generated in the ordered list R. The serial number is taken as the service serial number YWid corresponding to the current user. If the list is not published, all users in the first group repeat the step of the first sub-terminal generating the second random number Compᵢ until RegS publishes the ordered list R on the Web page.

The following needs to perform user quantity information synchronization. In FIG. 7, \textcircled{11} represents RegS submitting the number of users in each group corresponding to each Agent address to the Agent. If the number of users in the group has not changed, the submission to the corresponding Agent is not performed. The submission process can also be published through the Web page of RegS, and the Agent periodically queries the latest user quantity.

The initialization process is described below. Each user completes initialization on their own second sub-terminal, without the need to interact with other terminals or modules. The initialization algorithm is as follows.
Step 1: the current user i transferring the shared key InitKᵢⱼ from the first sub-terminal to the second sub-terminal for use, wherein the secure transfer methods include manual input, CD burning, and other offline methods.
Step 2: the current user i using the shared key InitKᵢⱼ as input on the second sub-terminal to calculate the first key Sᵢ. Specifically, it can be calculated according to the following formula:

$${s}_{i} = {\sum }_{j \neq i} {( - 1 )}^{j > ι} PRF ( {Initk}_{ij} ) mod ( P - 1 ) , \qquad Formula 1$$

where PRF is a pseudo-random generation algorithm, and its input can be InitKᵢⱼ, or a combination of InitKᵢⱼ with group shared information, such as groupid.

The Sᵢ serves as the first key used when the user performs unidirectional sending.
Step 3: the user generating an RSA public-private key pair (priKeyᵢ, pubKeyᵢ). In actual implementation, the RSA2048 algorithm can be uniformly adopted, or the ECC (elliptic curve cryptography) algorithm can be adopted.

Further, the second sub-terminal is configured to convert a request to be processed into a bit string, and segment the bit string according to a preset length to obtain a plurality of segmented blocks, wherein the preset length is a difference between a preset message block length L and a bit length corresponding to a preset number threshold; sequentially splice each segmented block with the service serial number YWid to obtain spliced blocks, wherein the service serial number YWid is positioned in the most significant bits of the spliced block; and determine a block sequence based on each spliced block,

take a first spliced block in the block sequence as a current spliced block, and fill the current spliced block into a preset message register RM; match a corresponding second sub-prime number Pᵢ₂ from the preset prime number table PT according to a value of the message register RM; calculate a second ciphertext E(Pᵢ₂) corresponding to the current spliced block based on the second sub-prime number Pᵢ₂, a value of a preset counter, the first key Sᵢ, and the preset first prime number P; send the second ciphertext E(Pᵢ₂) to the data processing server, and update the value of the counter; take a next spliced block in the block sequence as a new current spliced block, and repeatedly perform a step of filling the current spliced block into the preset message register until the second ciphertext E(Pᵢ₂) corresponding to a last spliced block in the block sequence is sent to the data processing server.

Further, the second sub-terminal is also configured to periodically obtain a value in the preset message register, and match a corresponding third sub-prime number Pᵢ₃ from the preset prime number table according to the value of the message register; calculate a third ciphertext E(Pᵢ₃) based on the third sub-prime number Pᵢ₃, the value T of a preset counter, the first key Sᵢ, and the preset first prime number P; send the third ciphertext E(Pᵢ₃) to the data processing server; update the value of the counter; and when no request to be processed exists, generate a third random number, splice the third random number to the service serial number YWid to obtain a splicing result, fill the splicing result into the preset message register, and repeatedly perform the step of periodically obtaining the value in the preset message register.

In actual implementation, as shown in FIG. 8, a schematic diagram of unidirectional message sending is provided. The figure illustrates the user message sending process in the unidirectional sending flow, where all users periodically and unidirectionally send messages to the Agent at the same time. The unidirectional sending process is divided into two parts: one being a unidirectional sending sub-process, and the other being a message segmentation sub-process.

The unidirectional sending sub-process is first described below.

The unidirectional sending sub-process is executed independently and cyclically as a separate process to ensure continuous sending in a timed and quantitative manner. This program is executed on the second sub-terminal.

The system is preset with a heartbeat value heart time, which, without loss of generality, can be set to 10 milliseconds to ensure that each node can effectively complete the process computation.

The system sets a message register RM with a length of L bits, and initially sets RM to 0. The system sets a counter, and initially, the counter value is 65537. The system sets a time register.
Step 1: querying the current system time systime, executing Step 2 if systime—time is greater than or equal to hearttime, and if not, looping Step 1. Here, systime can be understood as the current actual time, and time can be understood as the time of the last data transmission to the data processing server.
Step 2: matching the row number in the preset prime number table PT according to the value of the message register RM, and querying to obtain the corresponding prime number in that row, which is the third sub-prime number Pᵢ₃.
Step 3: the current user i calculating the third ciphertext E(Pᵢ₃) according to the following formula:

$$E ( {P}_{i 3} ) = {P}_{i 3} \cdot {Hash ( T )}^{{s}_{i}} mod P . \qquad Formula 2$$

Step 4: the current user i using the second sub-terminal to send the third ciphertext E(Pᵢ₃) to the Agent.
Step 5: increasing the value T of the counter of the current user i by 1, and updating “time” to be equal to systime. The increment value of T each time can also be set to other values, as long as it is consistent among users within the same group.
Step 6: generating a third random number, and combining it with YWid to fill the message register RM, wherein direct splicing can be adopted, the YWid is positioned in the most significant bits, and the third random number is positioned in the least significant bits; and looping back to Step 1.

The Hash function can be selected from cryptographic algorithms commonly used in practice, such as SHA1 (secure Hash algorithm), SHA256, or SHA512, and a Hash algorithm with salt value can also be used, for example, using the Agent address or DB address shared within the group as the salt value.

The message segmentation sub-process is described below.

Before sending the first request to be processed, the public key pubKeyᵢ of the current user needs to be sent to the Agent. The message segmentation sub-process is executed to perform block processing of the user public key pubKeyᵢ, and the sending is completed through the unidirectional sending sub-process.

Further, for each request to be processed Req to the service server S, the message segmentation sub-process needs to be executed independently to perform block processing of the request to be processed, and the sending is completed through the unidirectional sending sub-process.

The steps of the message segmentation sub-process are as follows.
Step 1: converting the request to be processed, which is to be sent, into a bit string, and segmenting it according to a preset length SL to obtain multiple segmented blocks, where the preset length SL is the message block length L minus the bit length of a preset quantity threshold (yN+1).
Step 2: sequentially concatenating each segmented block with the service serial number YWid of the current user in a bit string manner, where YWid is positioned in the most significant bits and each segmented block is positioned in the least significant bits, thereby constructing a new block sequence.
Step 3: taking the first spliced block in the block sequence as the current spliced block, filling the current spliced block into the message register RM, and recording the current value of the counter; according to the steps in the above unidirectional sending sub-process, matching the row number in the preset prime number table PT based on the value of the message register RM; querying the corresponding prime number in that row, which is the second sub-prime number Pᵢ₂; according to the calculation method in formula 2 above, replacing the third sub-prime number Pᵢ₃ in formula 2 with the second sub-prime number Pᵢ₂, computing to obtain the second ciphertext E(Pᵢ₂), and sending the second ciphertext E(Pᵢ₂) to the Agent; and exiting the process when the block sequence has reached the end.
Step 4: detecting the current value T of the counter when the block sequence has not reached the last block; when the value T of the counter has increased by 1, indicating that a message has been sent to the data processing server, then looping back to execute Step 3; and looping to execute Step 4 when the value T of the counter remains unchanged.

Further, the data processing server is configured to receive a target ciphertext according to an address of the second sub-terminal, store the target ciphertext into a corresponding ciphertext block queue in sequence according to the address, and calculate a second result M₂ each time according to target ciphertexts at the same position in each ciphertext block queue and the first prime number P, wherein the target ciphertext is the second ciphertext E(Pᵢ₂) or the third ciphertext E(Pᵢ₃).

The data processing server is configured to determine, for each prime number in the preset prime number table PT, whether the prime number is a factor of the second result M₂, and obtain a serial number corresponding to the prime number when the prime number is a factor of the second result M₂. The data processing server is configured to obtain a decryption result set according to the obtained multiple serial numbers, exclude the third random number from the decryption result set according to the service serial number YWid, and recover a recovered request to be processed corresponding to the service serial number YWid.

After completion of the above unidirectional sending process, the data processing server performs an aggregation computation process. The data processing server only needs to know the number of users in the first group, and the number of users is synchronized by the registration/logout server after user registration.

The data processing server needs to set three sets of queues for each user according to the number of users. A first queue QEi is used to store the second ciphertexts E(Pᵢ₂) sent from the second sub-terminal of the current user i; a second queue QRi is used to store the spliced blocks of the current user i; and a third queue QMi is used to store the restored requests to be processed of the current user i that are to be sent to the service server S. At the same time, the data processing server sets a public key list corresponding to the service serial number YWid.
Step 1: the data processing server respectively taking out one second ciphertext E(Pᵢ₂) from each queue QEi corresponding to each service address in a first-in-first-out manner. If some queues are empty, it is necessary to wait until all queues are not empty.
Step 2: the data processing server calculating a second result M₂ according to the following formula. It should be noted that the second ciphertexts synchronized and sent by users within the group are required here, and the synchronized second ciphertexts are used for the calculation.

$${M}_{2} = \prod E ( {P}_{i 2} ) mod P . \qquad Formula 3$$

Step 3: the data processing server using the prime numbers in the preset prime number table PT to compute the second results M₂ one by one, and check whether each prime is a factor of the second result M₂. If so, the serial number corresponding to the prime number is taken as a decryption result and recorded into a decryption result set.
Step 4: the data processing server cyclically checking each element in the decryption result set. If there are duplicate YWid values in the most significant bits, it proves that the system has lost synchronization. It can also be understood that each user in the first group corresponds to a different YWid; and if duplication occurs, it indicates an exception. In this case, the data processing server can feed back to the registration/logout server to cancel the group, reclaim and reuse the Agent and DB resources, and exit the process. If verification is passed, the process continues in a cyclic manner.

After the aggregation computation process is completed, request recovery processing is performed. Specifically, for each element Info in the decryption result set, the YWid which constitutes the most significant bits of Info, is extracted. Using the YWid as an index i, the second queue QRi is indexed. An element which is equal to the least significant bits of the Info (i.e. the remaining portion after the YWid is removed) is then appended to the end of QRi, wherein the appended element is equal to the after removal of the YWid.

The data processing server needs to cyclically detect each second queue QRi. Once a complete request to be processed can be reconstructed from the first segmented block in bit order, the reconstructed request to be processed is stored in the corresponding third queue QMi, and the reconstructed segmented blocks are removed from the second queue QRi.

The first message transmitted by the current user to the data processing server through the second sub-terminal will be the user public key pubKeyᵢ of the current user. Each user public key corresponds one-to-one to the service serial number of the user. After the user public key pubKeyᵢ is reconstructed through the above steps according to the service serial number YWid, it is stored in the public key list. The user public key pubKeyᵢ is used for encrypting the response messages corresponding to the subsequent YWid sequence numbers.

Further, the data processing server is in communication connection with a preset service server; the data processing server is configured to send each recovered request to be processed to the service server, and receive a response message corresponding to each recovered request to be processed returned by the service server; and determine a user public key pubKeyᵢ respectively corresponding to each service serial number YWid according to the service serial number YWid corresponding to each recovered request to be processed, so as to perform encryption processing respectively on each response message by using each user public key pubKeyᵢ to obtain each encrypted response message.

The data processing server checks the messages in each third queue QMi. According to the messages in each third queue, the data processing server sequentially starts a communication program to simulate that the user sends the restored request to be processed to the service server S and simultaneously receives a response message Resp.

The above simulated communication process uses the request to be processed of the user to complete a request-response communication process with the service server S. The simulated communication process can be separately designed according to the service server S, and the implementation can refer to the interface of the service server S and publicly available technical methods.

According to the simulated communication process described above, each response message corresponds to its respective service serial number YWid. By indexing the public key list with the service serial number YWid, the corresponding user public key is obtained, and each corresponding response message is encrypted separately. The specific public key encryption method can refer to publicly available technical methods, and is not repeated here. The encrypted response messages are transmitted and stored in the database server.

Further, the second sub-terminal is configured to periodically send a query request to the database server; the database server is configured to establish a message queue corresponding to the second sub-terminal according to a network address corresponding to the second sub-terminal, store each encrypted response message into the message queue, package all encrypted response messages in the message queue, and return the packaged messages to the second sub-terminal; the second sub-terminal is configured to perform attempt decryption on the packaged messages by using a user private key priKeyᵢ corresponding to the current user, and obtain a response message corresponding to the second sub-terminal based on a successfully decrypted message.

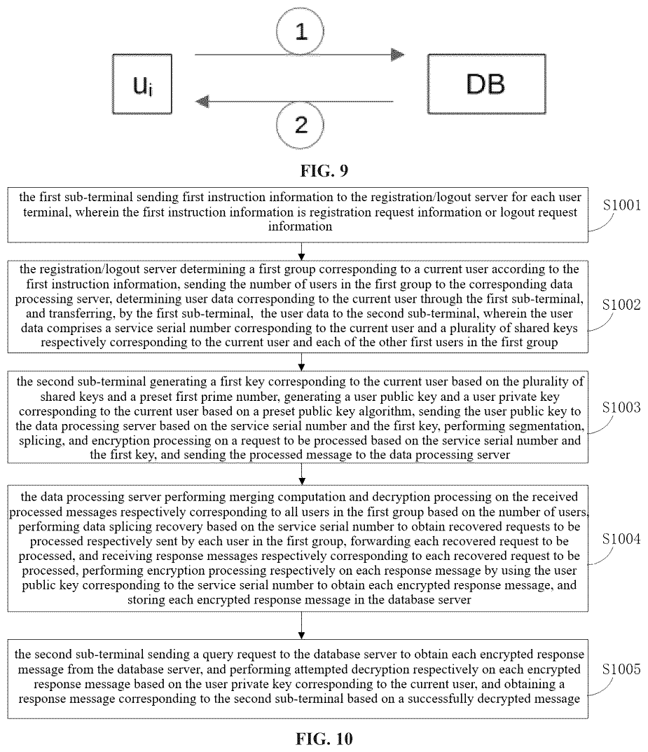

As shown in FIG. 9, which illustrates a schematic diagram of a privacy information query process, each user in the group can periodically query the latest messages in the database server. The database server ensures that all the latest messages are sent to every user in the group according to the following steps.
Step 1: the database server recording each newly arrived address and creating a new message queue according to the new address. Specifically, a respective message queue can be established for each second sub-terminal according to the address of each second sub-terminal, and the contents stored in each message queue are the same. In actual implementation, considering that different users in the same group can have different query frequencies, by setting respective corresponding message queues, each user accesses its own corresponding message queue, thereby avoiding omission of messages.
Step 2: each time the data processing server sending a new encrypted response message to the database server, the database server copying the latest encrypted response message to the end of each message queue.
Step 3: the database server packaging all encrypted response messages in the message queue corresponding to the address of the second sub-terminal, and sending the packaged messages at one time to the second sub-terminal, as shown in step \textcircled{2} of FIG. 9, in responding to that, if the user, as shown in step \textcircled{1} of FIG. 8, sends a query request to the database server through the second sub-terminal. After transmission, the message queue corresponding to the address is cleared.
Step 4: verifying, by each user after receiving the packaged messages, whether each encrypted response message included in the packaged messages can be decrypted with a private key of the user; when the encrypted response message cannot be decrypted, determining that the encrypted response message does not belong to the user; and when the encrypted response message can be decrypted, restoring the response message according to a decryption result.

In the embodiment, during the privacy query stage, to ensure that listeners cannot distinguish individual users, the second sub-terminal of each user should perform message queries to the database server periodically, using the same fixed period.

The following describes an application scenario for protecting user IP address information in bank website interactions. In implementation, a RegS website is provided for accepting user registration, recording user public key information and initial IP address information. A set of (Agent, DB) servers is provided to offer computing resources. After registration on the RegS website, the user can, according to the method described in the present disclosure, send service request messages to the bank website via the Agent, where the Agent acts as a proxy to complete interaction with the actual bank website. The user obtains the public-key encrypted response result by querying the DB server and attempts to decrypt it using the private key of the user. The correctly matching user private key can successfully decrypt the response message, thereby completing one business interaction. The user continues to send service request messages to the Agent, thereby completing multiple service interactions. After the user completes the current service interaction, the service terminal still continuously operates, so as to ensure that all users in the group send corresponding information to the Agent.

The above data encryption system can provide more comprehensive protection compared with current encrypted communication systems, but when deploying the system, it is still necessary to ensure that the data processing server and the database server are not controlled by attackers, so as to improve system security and ensure operation efficiency. Although the data processing server and the database server cannot perform analysis on metadata and cannot identify or distinguish user service addresses, the bank website should further provide audit and restriction at the RegS website, so as to ensure that computing resources actually serve users who truly need them.

The following describes alternative solutions related to the solutions of the present disclosure.
1. The users may not be grouped; an alternative solution is that all users are in the same group. When the number of users is large, a larger preset first prime number P is required to satisfy the fundamental theorem of arithmetic.
2. The user grouping algorithm may be replaced.

In one alternative solution, new users are randomly inserted into each group, and RegS (that is, the registration/logout server) performs re-division according to the user grouping threshold.

In another alternative solution, grouping is performed according to the computing capacity of a set of Agent (that is, data processing servers) and DB (that is, database servers) nodes, rather than according to the threshold, but according to the resource support capacity.

In another alternative solution, grouping is performed according to a preset service type. For example, different services, such as accessing facebook.com and accessing icbc.com.cn, are used as the grouping basis, and the selection is performed when visiting the RegS website at the registration address and submitting the public key. This solution can realize specialized deployment of the Agent, that is, several types of services use the same Agent.
3. For the privacy query process, an alternative solution is to adopt a privacy information extraction algorithm based on ID (identity document), the specific technology of which can refer to related techniques, which are not described herein again.
4. For the message segmentation and cutting in the unidirectional sending process, an alternative solution is to use message verification codes, message compression encoding, or the like in message generation or reconstruction.
5. In the unidirectional sending sub-process, for the filling value in the message register RM, an alternative solution is to fill in a fixed message, for example, fill in 0, and the corresponding prime number of the message is the first prime number 2 in the preset prime table PT.
6. In the above embodiments, the DH algorithm (Diffie-Hellman algorithm, a method for ensuring secure traversal of shared keys across insecure networks) and the RSA algorithm are used, wherein the DH algorithm can be replaced by the ECDH (elliptic curve Diffie-Hellman, a key exchange protocol based on an elliptic curve). The RSA can also be replaced by a combination of a public key algorithm and a symmetric encryption algorithm, and related technical solutions can refer to existing literature.
7. According to the technical solution, in fact, users in the group continuously send random messages from the second sub-terminal regardless of whether there is a request, so as to protect the normal use of other users in the group. An alternative solution is to set a longer online time requirement; that is, after registration, the user must be online for at least one day, so as to ensure that the members in the group have a relatively stable communication environment.
8. Since the DB has high requirements for communication bandwidth and low requirements for computation, in fact, a DB with sufficient bandwidth can serve multiple Agents; an alternative solution is that the DB can further distinguish and establish different message storage queues under different Agent addresses according to the addresses of the Agents.
9. In the design of the present technical solution, the user terminal is divided into a first sub-terminal and a second sub-terminal, and the two addresses are different, which increases the difficulty for attackers to associate service communication with network addresses. In fact, if the addresses of the first sub-terminal and the second sub-terminal are the same, according to the principle of the present technical solution, attackers are also difficult to perform an association between service communication and addresses.
10. The RegS, Agent, and DB can actually operate on the same server, or any two of them can operate on the same server.
11. In the present technical solution, all service communication contents of the user are independent of the network address of the user.

An alternative solution is that the user terminal uses three addresses, that is, a registration address, a service address, and a query address, wherein the registration address only performs publishing of the user public key and random number for sequencing; the service address only performs the unidirectional sending process; and the query address performs a query to RegS or DB.

Another alternative solution is that each query to the DB and RegS uses a dynamic address, and the service address is relatively fixed.
12. The disposal solution after aggregation computation failure can be replaced. An alternative solution is that the Agent notifies the RegS module, the user queries the aggregation computation failure information, and then each user resets the counter in the unidirectional sending sub-process.

In the above encrypted communication system, the second sub-terminal segments the user public key and the request to be processed, and concatenates them with the service serial number, encrypts and sends the concatenated segments to the data processing server based on the first key, the first prime number, and the preset prime number table. The data processing server, after receiving messages of all users in the first group, performs merging computation and decryption processing, and restores the user public key and the real request to be processed based on the service serial number. The data processing server sends out the service request according to the real request to be processed and receives the response message. The response message is encrypted using the user public key corresponding to the service serial number and stored on the database server. The second sub-terminal obtains all encrypted response messages from the database server and attempts to decrypt each encrypted response message using the user private key, and obtains the response message belonging to the user from the successfully decrypted response messages. The system can realize protection by obfuscation of user communication metadata, thereby improving the security of the encrypted communication system.

The present disclosure provides protection for user network address, communication time, communication length, and the like, particularly ensuring the untraceability of the user network address. The present scheme provides an encrypted communication system for message communication constructed using a one-way non-interactive channel, which can be adapted to current typical encrypted service systems. Through comprehensive protection of metadata, the system provides functions such as untraceable user network address and non-disclosure of user behavior information, and is capable of ensuring information security protection of service system terminal users under circumstances such as large-scale monitoring, information system vulnerabilities, and internal malicious administrators, thus having application value for revolutionizing current typical encrypted communication service systems.

The system provides unidirectional sending, aggregation computation, and request recovery algorithms, which ensure that even in the presence of n−2 untrusted users and untrusted RegS, Agent, and DB, these untrusted parties cannot trace back which address the sending content originates from, even through collusion. The system provides a supporting multi-party computation negotiation algorithm, which does not require a centralized key generation and distribution institution, and users within the group can independently complete subsequent communication. Each encrypted communication of the system is completed under multi-party participation, which, although consuming bandwidth, conceals the communication behavior of each user, so that attackers cannot trace the relationship between behavior and address. The system provides a communication method that is not bound to addresses, wherein the registration address and the service address of the user are separated, thereby enhancing untraceability.

The above encrypted communication system designs a communication architecture using non-interactive unidirectional sending of service requests, and simultaneously constructs a corresponding request/response transmission and reception loop using privacy query technology. It has characteristics such as distinct round-trip messages and non-interactive transmission, which can effectively protect the user service address from being distinguished.

The system designs a novel cryptographic algorithm based on the disorder of factorization and the discrete logarithm problem. Supporting mechanisms such as synchronous sending, timed sending, and broadcast replying are adopted to ensure efficient operation of the encryption and decryption mechanisms. The present system designs a supporting key initialization algorithm based on multi-party computation, which can complete reliable key initialization even when the receiver and part of the users within the group are untrusted. The present system designs an interface based on an Agent that simulates user behavior to connect with the original service server. The system can be directly superimposed on the original service system without modifying it, thereby realizing rapid deployment and compensating for the deficiency of the original system in protecting user metadata information. The present system designs a queue based on the Agent for simultaneously receiving and caching all user messages, and a working mode in which all user messages at a given moment must be used simultaneously for computation to decrypt all messages. The present system designs a mechanism that can automatically operate based on its own system time and counter, without requiring time synchronization. The present system designs a message-to-prime encoding method utilizing a preset prime number table. The present system designs a method for classifying Agents based on computing resources or service types. The present system designs a method for separating registration, service, and query addresses from each other. The present system designs a communication architecture that supports completely dynamic and variable addresses. That is, using a user sequencing algorithm and a message segmentation algorithm, the system supports message reassembly and response queries.

Compared with the prior art, the encrypted communication system of the present scheme has the following advantages.
Advantage 1: It can resist encrypted channel behavior analysis in a large-scale monitoring environment, protecting the service IP address of the user, and metadata information such as communication time, communication frequency, and message length.

Firstly, the dual-address network architecture and the unidirectional sending sub-process design protect the service address.

The user registration address can be obtained through other means, such as using a temporary VPN (virtual private network) channel or a VPS (virtual private server), and after completing the initialization registration together with other users, this address may no longer be used. At the same time, the registration address can continuously change without affecting service operation.

Both the service address and registration address can continuously change. However, since the service may involve a large number of repeated interactions, even if the address does not change, based on the following analysis, it can still be ensured that the service address and specific service do not form a traceable relationship.

When the Agent receives messages sent by users, each message is encrypted. Based on the disorder of prime factorization and the difficulty of solving the discrete logarithm problem, and referring to the above Formula 1, Formula 2, and Formula 3, the following conclusion can be drawn:

$$\sum {s}_{i} = 0 mod ( P - 1 ) ;$$

$$M = \prod {P}_{i} \cdot {Hash ( T )}^{{s}_{i}} mod P = {Hash ( T )}^{\sum {s}_{i}} \cdot \prod {P}_{i} mod P = \prod {P}_{i} mod P ;$$

furthermore, due to the length limitation of Pᵢ, the sum of all Pᵢ lengths is smaller than the length of P, so finally the following is obtained:

$$M = \prod {P}_{i} .$$

According to the fundamental theorem of arithmetic, M has a unique prime factorization form. Therefore, by querying the preset prime number table PT based on M, one set of plaintext can be uniquely restored. Based on the disorder property of the prime numbers recovered from the factorization of M, as long as more than two users among n users are honest and reliable, that is, they do not collude with each other, it can be ensured that it is impossible to distinguish which service address of the honest and reliable user sent the service request data.

Secondly, the unidirectional sending sub-process protects information such as sending time and sending data volume.

When the Agent receives the m-th message from a single user, it must cache it for a period of time until the m-th message from every user arrives, and then uniformly perform the merging operation for all users in the group. Even for users without service requests, their second sub-terminals will also periodically send random numbers; otherwise, the system will lose synchronization, and the resources will be reclaimed. Therefore, it is impossible to associate specific communication metadata, such as the sending time or the data volume of the service request message of a specific user, with a specific service address information.

Similarly, in the response message acquisition stage, since the privacy query algorithm based on public key encryption is adopted, each user can receive every encrypted response message. Therefore, in fact, users also cannot be distinguished based on the response messages. Finally, due to the protection of public key encryption, only the real user can decrypt the response message belonging to themselves.

Finally, based on the mode of each user periodically sending random messages and periodically sending privacy query requests, it is impossible, as in conventional encryption systems, to collect metadata information capable of distinguishing user behaviors.
Advantage 2: It can ensure that user service address information is not disclosed even when the service server S, data processing server Agent, database server DB, registration/logout server RegS, and other components are all compromised by system intrusion.

Under large-scale system intrusion, conventional encryption systems may face data loss, potential disruption of business processes, and user traceability. However, under such circumstances, using the communication system in the present disclosure can still provide protection for the user service address information.

As described above, the business system IP address cannot be associated with specific service requests or responses on connected Agents or DBs. At the same time, the service system IP address is not directly connected to the service server S. Additionally, the present disclosure provides a separate registration IP address, which is used to complete user registration, logout, and algorithm initialization based on multi-party computation. After initialization, the shared key information in fact can also be imported offline from the local to the user terminal using the service address. Therefore, in all stages, specific service behaviors are never explicitly associated with user service IP addresses.

Particularly in systems with a large number of service users, the service IP address of any user is masked among numerous indistinguishable service IP addresses, preventing effective distinction.

Similarly, in the presence of internal malicious administrators, the system does not pose a risk of user service IP address leakage.
Advantage 3: The system does not rely on centralized key management, providing higher security.

In fact, both the sender protection algorithm and the privacy query algorithm do not involve a key center or centralized trust relationships. This decentralized key generation can avoid the risks associated with conventional key distribution centers.

In conventional encrypted communication systems, the key center controls the keys of all users, or the service server S can control and hold all communication keys across service communication directions. Therefore, internal malicious administrators inside the system or external attackers can easily use the keys they possess to decrypt and monitor nearly all service data at any time.

According to the conclusions derived from formula 1, formula 2, and formula 3, and according to the computational difficulty of the discrete logarithm problem, no party can independently decrypt any message related to user service addresses during system operation.

Furthermore, the first key Sᵢ in the sender protection algorithm held by each user is computed on the user side through multi-party collaboration and pairwise communications, and no party can steal or forge it. Thus, the system design implements decentralized key distribution.
Advantage 4: For the system, it cannot track real users based on controlled business servers by embedding traffic fingerprints.

In conventional encrypted communication systems, internal malicious administrators or attackers who successfully penetrate the system may embed traffic fingerprints in response information and ultimately locate user service IP addresses by tracing these fingerprints. Such traffic fingerprints usually consist of a set of messages with specific lengths.

However, the present disclosure employs a privacy query-based response message query technology. Even if an attacker or malicious administrator controls the Agent and embeds a traffic watermark in the response message, since every user actually receives the public key encrypted result of every response message, it is impossible to determine which user corresponds to which service response message. Consequently, traffic fingerprints are invalidated.

In summary, the present disclosure designs a network architecture using a one-way transmission channel, applies a sender protection algorithm to protect service sending addresses, and employs a privacy query algorithm to construct a closed message loop. This effectively protects user service IP address information, communication time, communication frequency, message length, and other metadata information, and improves the security of encrypted systems under large-scale monitoring, system vulnerabilities, internal malicious administrators, and other complex adversarial environments. The system addresses the demand for enhanced privacy protection in encryption systems, maximally considers potential risks faced by information systems, provides information encryption protection, and effectively safeguards communication metadata. It offers a more secure and effective encryption protection technology for national-level cybersecurity scenarios and reduces security risks for critical core services.

An embodiment of the present disclosure further provides an encrypted communication method. As shown in FIG. 10, the method includes the following steps:
Step S1001, the first sub-terminal sending first instruction information to the registration/logout server for each user terminal, wherein the first instruction information is registration request information or logout request information;
Step S1002, the registration/logout server determining a first group corresponding to a current user according to the first instruction information, sending the number of users in the first group to the corresponding data processing server, determining user data corresponding to the current user through the first sub-terminal, and transferring, by the first sub-terminal, the user data to the second sub-terminal, wherein the user data comprises a service serial number corresponding to the current user and a plurality of shared keys respectively corresponding to the current user and each other first user in the first group;
Step S1003, the second sub-terminal generating a first key corresponding to the current user based on the plurality of shared keys and a preset first prime number, generating a user public key and a user private key corresponding to the current user based on a preset public key algorithm, sending the user public key to the data processing server based on the service serial number and the first key, performing segmentation, splicing, and encryption processing on a request to be processed based on the service serial number and the first key, and sending the processed message to the data processing server;
Step S1004, the data processing server performing merging computation and decryption processing on the received processed messages respectively corresponding to all users in the first group based on the number of users, performing data splicing recovery based on the service serial number to obtain recovered requests to be processed respectively sent by each user in the first group, forwarding each recovered request to be processed, and receiving response messages respectively corresponding to each recovered request to be processed, performing encryption processing respectively on each response message by using the user public key corresponding to the service serial number to obtain each encrypted response message, and storing each encrypted response message in the database server; and
Step S1005, the second sub-terminal sending a query request to the database server to obtain each encrypted response message from the database server, and performing attempted decryption respectively on each encrypted response message based on the user private key corresponding to the current user, and obtaining a response message corresponding to the second sub-terminal based on a successfully decrypted message.

The encrypted communication method can realize protection by obfuscation of user communication metadata, thereby improving the security of the encrypted communication system.

Finally, it should be stated that the above embodiments are only used to illustrate the technical solutions of the present disclosure, and not to limit them; although the present disclosure has been described in detail with reference to the aforementioned embodiments, it should be understood by those skilled in the art that modifications can still be made to the technical solutions recorded in the above embodiments, or equivalent replacements can be made for some or all of the technical features therein; and these modifications or replacements do not cause the essence of the corresponding technical solutions to depart from the scope of the technical solutions in the embodiments of the present disclosure.

1. An encrypted communication system, wherein the system comprises: a plurality of user terminals, a registration/logout server, a data processing server, and a database server; and each of the user terminals comprises: a first sub-terminal and a second sub-terminal; network addresses corresponding to the first sub-terminal and the second sub-terminal are different;
the first sub-terminal is configured to send first instruction information to the registration/logout server for each of the user terminals, wherein the first instruction information is registration request information or logout request information;
the registration/logout server is configured to determine a first group corresponding to a current user according to the first instruction information, send the number of users in the first group to a corresponding data processing server, determine user data corresponding to the current user through the first sub-terminal, and transfer, by the first sub-terminal, the user data to the second sub-terminal; and the user data comprises a service serial number corresponding to the current user and a plurality of shared keys respectively corresponding to the current user and each other first user in the first group; the second sub-terminal is configured to generate a first key corresponding to the current user based on the plurality of shared keys and a preset first prime number, generate a user public key and a user private key corresponding to the current user based on a preset public key algorithm, send the user public key to the data processing server based on the service serial number and the first key, perform segmentation, splicing, and encryption processing on a request to be processed based on the service serial number and the first key, and send the processed message to the data processing server;
the data processing server is configured to perform merging computation and decryption processing on the received processed messages respectively corresponding to all users in the first group based on the number of users, perform data splicing recovery based on the service serial number to obtain recovered requests to be processed respectively sent by each user in the first group, forward each recovered request to be processed, and receive response messages respectively corresponding to each recovered request to be processed, perform encryption processing respectively on each response message by using the user public key corresponding to the service serial number to obtain each encrypted response message, and store each encrypted response message in the database server; and
the second sub-terminal is configured to send a query request to the database server to obtain each encrypted response message from the database server, and perform attempted decryption respectively on each encrypted response message based on the user private key corresponding to the current user, and obtain a response message corresponding to the second sub-terminal based on a successfully decrypted message.

2. The system according to claim 1, wherein
for each of the user terminals, the first sub-terminal of the user terminal is configured to generate a first random number and take the first random number as a first private key of the current user, and calculate a first public key corresponding to the current user according to the first private key and a preset initialization prime number;
the first sub-terminal is configured to send the first instruction information to the registration/logout server, wherein when the first instruction information is the registration request information, the registration request information comprises a registration instruction and the first public key corresponding to the current user; and when the first instruction information is the logout request information, the logout request information comprises a logout instruction and the first public key corresponding to the current user;
the registration/logout server is configured to determine the first group corresponding to the current user according to the first instruction information, and send a second public key corresponding to each of other first users in the first group to the first sub-terminal; and
the first sub-terminal is configured to calculate the plurality of shared keys respectively corresponding to the current user and each of the other first users in the first group based on the first private key of the current user, the second public key corresponding to each of the other first users in the first group, and the preset initialization prime number.

3. The system according to claim 1, wherein
the registration/logout server is configured to, when the first instruction information is the registration request information, determine whether user information of other users exists in the registration/logout server; record, when the number of other users is less than two, the first public key corresponding to the current user, and determine a user group and a group number corresponding to the user group corresponding to the current user and the other users, and a user number corresponding to each user in the user group; and
generate a new user group when the number of other users is not less than two, and when the number of users in a last user group is greater than a preset number threshold, wherein the preset number threshold is a preset user group threshold plus one, and the new user group comprises: users whose user numbers in the last user group are greater than or equal to the user group threshold, and the current user;
different user groups correspond to data processing servers having different addresses and/or ports, and correspond to database servers having different addresses and/or ports; and
each user in the same user group corresponds to a data processing server having the same address and port, and a database server having the same address and port.

4. The system according to claim 3, wherein
the first sub-terminal is further configured to calculate an initialization key corresponding to the current user based on the plurality of shared keys in the first group, preset first group common information, and the preset first prime number; and
the first sub-terminal is configured to generate a second random number, take the second random number as an index serial number, query a preset prime number table to obtain a corresponding first sub-prime number, calculate a first ciphertext corresponding to the current user based on the first sub-prime number, second group common information, and the initialization key, and
send the first ciphertext to the registration/logout server.

5. The system according to claim 4, wherein
the registration/logout server is configured to calculate a first result according to the received first ciphertext respectively corresponding to each user in the first group, and the preset first prime number;
the registration/logout server is configured to, for each prime number in the preset prime number table, determine whether the prime number is a factor of the first result;
obtain, when the prime number is the factor of the first result, a serial number corresponding to the prime number; and
sort the obtained multiple serial numbers in ascending order to obtain an ordered list; and send the ordered list to the first sub-terminal to enable the current user to determine a service serial number corresponding to the current user according to a serial number of the second random number in the ordered list.

6. The system according to claim 5, wherein
the second sub-terminal is configured to convert the request to be processed into a bit string, and segment the bit string according to a preset length to obtain a plurality of segmented blocks, wherein the preset length is a difference between a preset message block length and a bit length corresponding to the preset number threshold;
sequentially splice each segmented block with the service serial number to obtain a spliced block, wherein the service serial number is positioned in the most significant bits of the spliced block;
determine a block sequence based on each spliced block;
take a first spliced block in the block sequence as a current spliced block, and fill the current spliced block into a preset message register;
match a corresponding second sub-prime number from the preset prime number table according to a value of the message register; calculate a second ciphertext corresponding to the current spliced block based on the second sub-prime number, a value of a preset counter, the first key, and the preset first prime number; and
send the second ciphertext to the data processing server, and update the value of the counter; and take a next spliced block in the block sequence as a new current spliced block, and repeatedly perform a step of filling the current spliced block into the preset message register until a second ciphertext corresponding to a last spliced block in the block sequence is sent to the data processing server.

7. The system according to claim 6, wherein
the second sub-terminal is further configured to periodically obtain the value in the preset message register, and match a corresponding third sub-prime number from the preset prime number table according to the value of the message register; calculate a third ciphertext based on the third sub-prime number, the value of the preset counter, the first key, and the preset first prime number;
send the third ciphertext to the data processing server;
update the value of the counter; and
when no request to be processed exists, generate a third random number, splice the third random number to the service serial number to obtain a splicing result, fill the splicing result into the preset message register, and repeatedly perform a step of periodically obtaining the value in the preset message register.

8. The system according to claim 7, wherein
the data processing server is configured to receive a target ciphertext according to an address of the second sub-terminal, store the target ciphertext into a corresponding ciphertext block queue in sequence according to the address, and calculate a second result each time according to target ciphertexts at the same position in each ciphertext block queue and the first prime number, wherein the target ciphertext is the second ciphertext or the third ciphertext;
the data processing server is configured to determine, for each prime number in the preset prime number table, whether the prime number is a factor of the second result, and obtain a serial number corresponding to the prime number when the prime number is the factor of the second result; and
the data processing server is configured to obtain a decryption result set according to the obtained multiple serial numbers; and
exclude the third random number from the decryption result set according to the service serial number, and recover a recovered request to be processed corresponding to the service serial number.

9. The system according to claim 1, wherein the data processing server is in communication connection with a preset service server; and
the data processing server is configured to send each recovered request to be processed to the service server, and receive a response message corresponding to each recovered request to be processed returned by the service server; and
determine a user public key respectively corresponding to each service serial number according to the service serial number corresponding to each recovered request to be processed, so as to perform encryption processing respectively on each response message by using each user public key to obtain each encrypted response message.

10. The system according to claim 1, wherein
the second sub-terminal is configured to periodically send a query request to the database server;
the database server is configured to establish a message queue corresponding to the second sub-terminal according to a network address corresponding to the second sub-terminal, store each encrypted response message into the message queue, package all encrypted response messages in the message queue, and return the packaged messages to the second sub-terminal; and
the second sub-terminal is configured to perform attempt decryption on the packaged messages by using the user private key corresponding to the current user, and obtain a response message corresponding to the second sub-terminal based on a successfully decrypted message.

11. An encrypted communication method, wherein the method comprises:
a first sub-terminal sending first instruction information to a registration/logout server for each user terminal, wherein the first instruction information is registration request information or logout request information;
a registration/logout server determining a first group corresponding to a current user according to the first instruction information, sending the number of users in the first group to a corresponding data processing server, determining user data corresponding to the current user through the first sub-terminal, and sending the user data to a second sub-terminal, wherein the user data comprises a service serial number corresponding to the current user and a plurality of shared keys respectively corresponding to the current user and each other first user in the first group;
the second sub-terminal generating a first key corresponding to the current user based on the plurality of shared keys and a preset first prime number, generating a user public key and a user private key corresponding to the current user based on a preset public key algorithm, sending the user public key to the data processing server based on the service serial number and the first key, performing segmentation, splicing, and encryption processing on a request to be processed based on the service serial number and the first key, and sending the processed message to the data processing server;
the data processing server performing merging computation and decryption processing on the received processed messages respectively corresponding to all users in the first group based on the number of users, performing data splicing recovery based on the service serial number to obtain recovered requests to be processed respectively sent by each user in the first group, forwarding each recovered request to be processed, and receiving response messages respectively corresponding to each recovered request to be processed, performing encryption processing respectively on each response message by using the user public key corresponding to the service serial number to obtain each encrypted response message, and storing each encrypted response message in a database server; and
the second sub-terminal sending a query request to the database server to obtain each encrypted response message from the database server, and performing attempted decryption respectively on each encrypted response message based on the user private key corresponding to the current user, and obtaining a response message corresponding to the second sub-terminal based on a successfully decrypted message.
